(19) United States
(12) Patent Application Publication
(10) Pub. No.: US 2026/0290731 A1
(43) Pub. Date: Sep. 24, 2026

(54) LINEAR PUFFER SWITCH

(71) Applicant: G & W Electric Company, Bolingbrook, IL (US)

(72) Inventors: Andres Laso, Chicago, IL (US); Nenad Uzelac, St. John, IN (US); Kennedy Darko, Bolingbrook, IL (US)

(21) Appl. No.: 19/576,621

(22) Filed: Mar. 24, 2026

Related U.S. Application Data
(60) Provisional application No. 63/776,905, filed on Mar. 24, 2025.

(51) Int. Cl. H01H 33/88; H01H 33/70

(52) U.S. Cl. CPC H01H 33/88; H01H 33/7015

(57) ABSTRACT

An electrical switch assembly includes a stationary conductor having a stationary electrode, a movable conductor movable relative to the stationary conductor between a closed position, in which the movable conductor and the stationary conductor are electrically connected, and an open position, in which the movable conductor and the stationary conductor are separated to interrupt the electrical connection between the movable conductor and the stationary conductor, and a piston tube configured to slidably receive the movable conductor. The electrical switch assembly also includes a nozzle coupled to the movable conductor that is configured to compress a dielectric gas and direct a pulse of the gas around the stationary conductor in response to movement of the movable conductor from the closed position toward the open position, an electrically insulating overmold surrounding a tip portion of the movable conductor, and a voltage screen electrically connected to the movable conductor.

### CROSS-REFERENCE TO RELATED APPLICATIONS

This application claims priority to co-pending U.S. Provisional Patent Application No. 63/776,905 filed on March 24, 2025, the entire content of which is incorporated herein by reference.

### FIELD

The present disclosure relates to an electrical switching device, and more particularly to a gas-insulated linear puffer switch.

### BACKGROUND

Various mechanisms exist for switching high electric currents in electric power distribution systems. In the case of load breakers for distribution networks, linear puffer technology is commonly used. This technology makes use of a flow of gas to quench the arc generated during the displacement of two electrodes. To limit arcing, such mechanisms are often filled with an inert, electrically insulating and high thermal capacity gas, such as sulfur hexafluoride (SF6) to quench the arc more effectively.

### SUMMARY

Although SF6 has very high dielectric performance allowing for more compact and simple designs, it is a greenhouse gas that is increasingly the subject of regulations restricting its use. Accordingly, a need exists for a linear puffer switch able to quench an arc effectively without using SF6 gas while remaining as compact as possible.

Thus, the present disclosure provides, among other things, an electrical switch including integrated screens for reducing electrical fields on the conductors. This allows for a more compact design, requiring a smaller insulation gap in the open position to withstand the electrical fields between the conductors.

In some aspects, the techniques described herein relate to an electrical switch assembly including: a stationary conductor having a stationary electrode; and a movable conductor movable relative to the stationary conductor between a closed position, in which the movable conductor and the stationary conductor are electrically connected, and an open position, in which the movable conductor and the stationary conductor are separated to interrupt the electrical connection between the movable conductor and the stationary conductor; a piston tube configured to slidably receive the movable conductor; a nozzle coupled to the movable conductor, the nozzle configured to compress a dielectric gas and direct a pulse of the gas around the stationary conductor in response to movement of the movable conductor from the closed position toward the open position; an electrically insulating overmold surrounding a tip portion of the movable conductor; and a voltage screen electrically connected to the movable conductor.

In other aspects, the techniques described herein relate to a method of manufacturing an electrical switch assembly that includes providing a piston tube, embedding a first voltage screen into a first electrically-insulating epoxy overmold, coupling the first electrically-insulating epoxy overmold to a movable conductor, and inserting the movable conductor within the piston tube. The method also includes embedding a second voltage screen into a second electrically-insulating epoxy overmold, coupling the second electrically-insulating epoxy overmold to a stationary conductor, and coupling the piston tube to the second electrically-insulating epoxy overmold.

In other aspects, the techniques described herein relate to an electrical switch assembly that includes a stationary conductor having a stationary electrode, and a movable conductor movable relative to the stationary conductor between a closed position, in which the movable conductor and the stationary conductor are electrically connected, and an open position, in which the movable conductor and the stationary conductor are separated to interrupt the electrical connection between the movable conductor and the stationary conductor. The electrical switch assembly also includes a piston tube configured to slidably receive the movable conductor, a nozzle coupled to the movable conductor and being configured to compress a dielectric gas and direct a pulse of the gas around the stationary conductor in response to movement of the movable conductor from the closed position toward the open position, a first electrically insulating overmold surrounding a tip portion of the movable conductor, and a second electrically insulating overmold surrounding the stationary electrode. The electrical switch assembly also includes a first voltage screen embedded within the first electrically insulating overmold and electrically connected to the movable conductor, and a second voltage screen embedded within the second electrically insulated overmold and electrically connected to the stationary conductor.

Other features and aspects of the disclosure will become apparent by consideration of the following detailed description and accompanying drawings.

### BRIEF DESCRIPTION OF THE DRAWINGS

FIG. 1 is a perspective view of a linear puffer switch assembly according to an embodiment of the present disclosure.

FIG. 2 is a cross-sectional view of the linear puffer switch assembly of FIG. 1, illustrating the switch assembly in an open state.

FIG. 3 is a cross-sectional view similar to FIG. 2, illustrating the switch assembly in a closed state.

FIG. 4 is an enlarged cross-sectional view of the linear puffer switch assembly of FIG. 1, illustrating a movable conductor having a nozzle that is engaged with a stationary conductor.

FIG. 5 is an enlarged cross-sectional view similar to FIG. 4, illustrating a pulse of a gas moving past the stationary conductor concurrently with the nozzle disengaging and moving away from the stationary conductor.

FIG. 6 is an enlarged cross-sectional view similar to FIG. 4, illustrating the switch assembly in the open state.

FIG. 7 is a perspective view of a linear puffer switch assembly according to another embodiment of the present disclosure, with portions hidden for the purpose of illustration.

FIG. 8 is a cross-sectional view of the linear puffer switch assembly of FIG. 7, illustrated in a closed state.

FIG. 9 is a cross-sectional view of the linear puffer switch assembly of FIG. 7, illustrated moving from the closed state toward an open state, just prior to separation of the conductors.

FIG. 10 is a cross-sectional view of the linear puffer switch assembly of FIG. 7, illustrated moving from the closed state toward the open state, after separation of the conductors.

FIG. 11 is a cross-sectional view of the linear puffer switch assembly of FIG. 7, illustrated moving further towards the open state.

FIG. 12 is a cross-sectional view of the linear puffer switch assembly of FIG. 7, illustrated in the open state.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

Also, it is to be understood that the phraseology and terminology used herein is for the purpose of description and should not be regarded as limiting. For example, the use of directional terms such as upper, lower, top, bottom, left, and right are used for descriptive purposes only with reference to the particular orientations illustrated in the figures.

### DETAILED DESCRIPTION

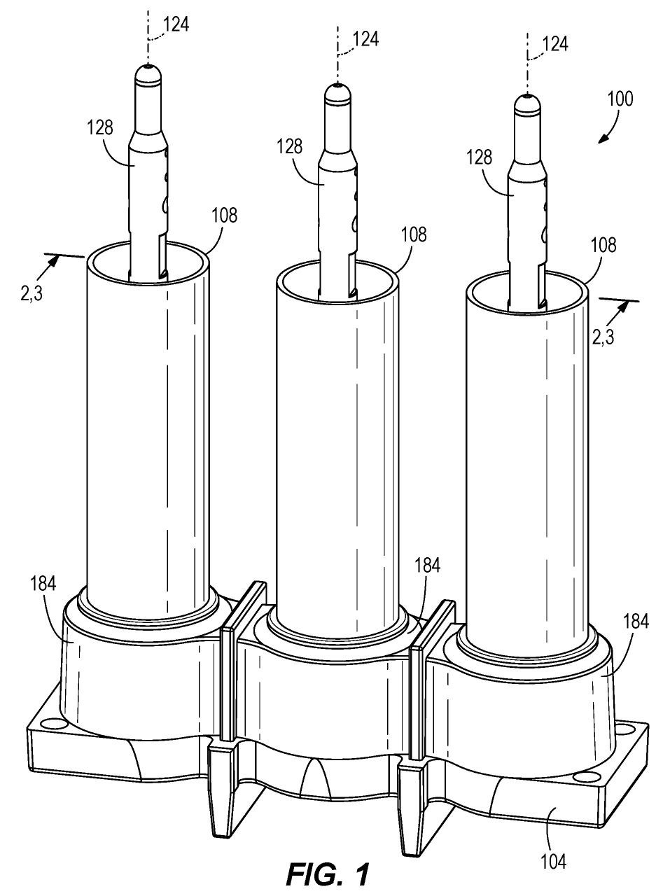

FIG. 1 illustrates an electrical puffer switch assembly 100 according to an embodiment of the present disclosure. The electrical puffer switch assembly 100 is a high-current electrical switch that selectively allows electrical current to pass through when the switch is closed. High-current electrical switches, such as the electrical puffer switch assembly 100 are subject to electrical arcing as the switch is closing and opening, thereby causing the conductors to erode. As described in greater detail below, the electrical puffer switch assembly 100 reduces the electrical field on the conductors when the switch is in the open position, allowing a more compact design by reducing the required insulation gap in the open position between the stationary and movable electrodes without requiring the use of sulfur hexafluoride (SF6) gas.

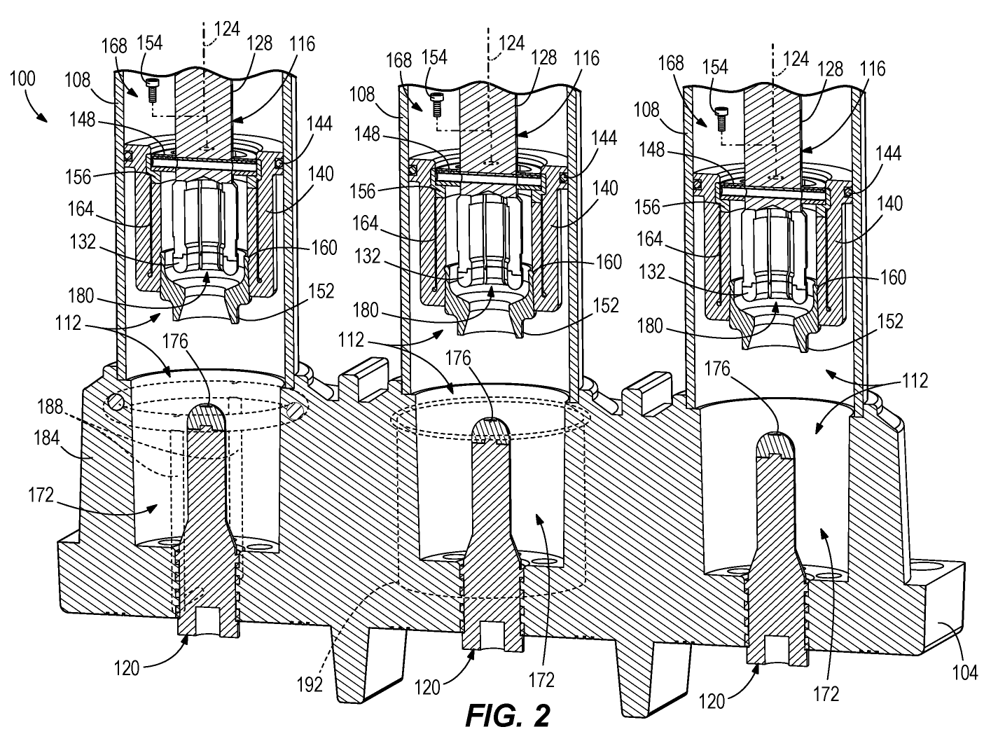

With reference to FIGS. 1 and 2, the electrical puffer switch assembly 100 includes a base 104 and a plurality of piston tubes 108 coupled to the base 104. Specifically, the base 104 receives the plurality of piston tubes 108. The electrical puffer switch assembly 100 further includes a plurality of conductor sets 112. Each set of conductors 112 is supported by the base 104 and one of the piston tubes 108. Each set of conductors 112 includes a movable conductor 116 and a stationary conductor 120. Each piston tube 108 slidably receives one of the movable conductors 116. That is, each movable conductor 116 is movable along a longitudinal axis 124 of the piston tube 108. In the illustrated embodiment, there are three sets of conductors 112, while in other embodiments, there may alternatively be fewer or greater than three sets of conductors 112.

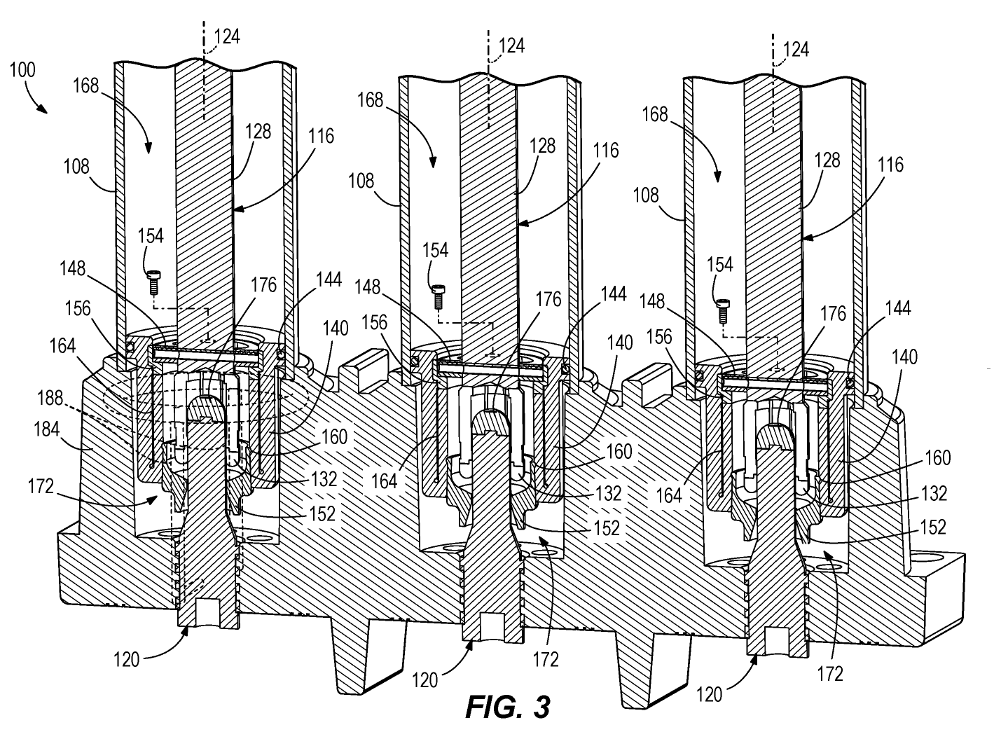

With reference to FIGS. 2 and 3, the plurality of conductor sets 112 are movable in unison between an open state (FIG. 2), in which each movable conductor 116 is spaced away from the respective stationary conductor 120, and a closed state (FIG. 3), in which each movable conductor 116 is engaged with the respective stationary conductor 120. Each movable conductor 116 and each stationary conductor 120 is substantially identical, so only one movable conductor 116 and one stationary conductor 120 will be further described for the sake of brevity.

With reference to FIGS. 2-6, the movable conductor 116 includes a rod 128 that is disposed coaxial with the longitudinal axis 124 of the piston tube 108 and an electrode tip 132 disposed at a distal end of the rod 128. The rod 128 and the electrode tip 132 are conductively connected such that they are at the same potential. A first overmold 140 is disposed around the tip 132 and acts as a piston at the end of the rod 128, such that the first overmold 140 seals against the inner periphery of the piston tube 108 via a seal 144 (i.e., gasket, O-ring, etc.). A mounting ring 148 is coupled to the rod 128 and supports the first overmold 140 relative to the rod 128. Specifically, a series of fasteners 154 couple the mounting ring 148 to a flange 156 of the first overmold 140. There is also a nozzle 152 coupled to the movable conductor 116 via the first overmold 140. That is, the nozzle 152 includes a lip 160 that is received by the first overmold 140 to inhibit the nozzle 152 from moving relative to the first overmold 140. The nozzle 152 is, therefore, supported and at least partially surrounded by the first overmold 140. Also, the nozzle 152 is disposed adjacent the tip 132. Specifically, the nozzle 152 is disposed around (i.e., radially surrounds) the tip 132 and may also receive the stationary conductor 120 when the set of conductors 112 are in a closed state (FIG. 3).

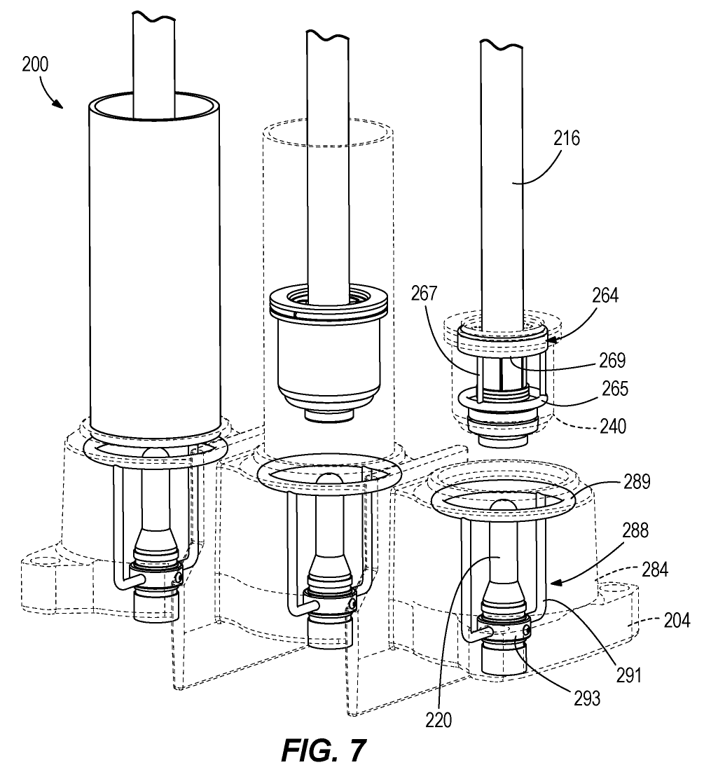

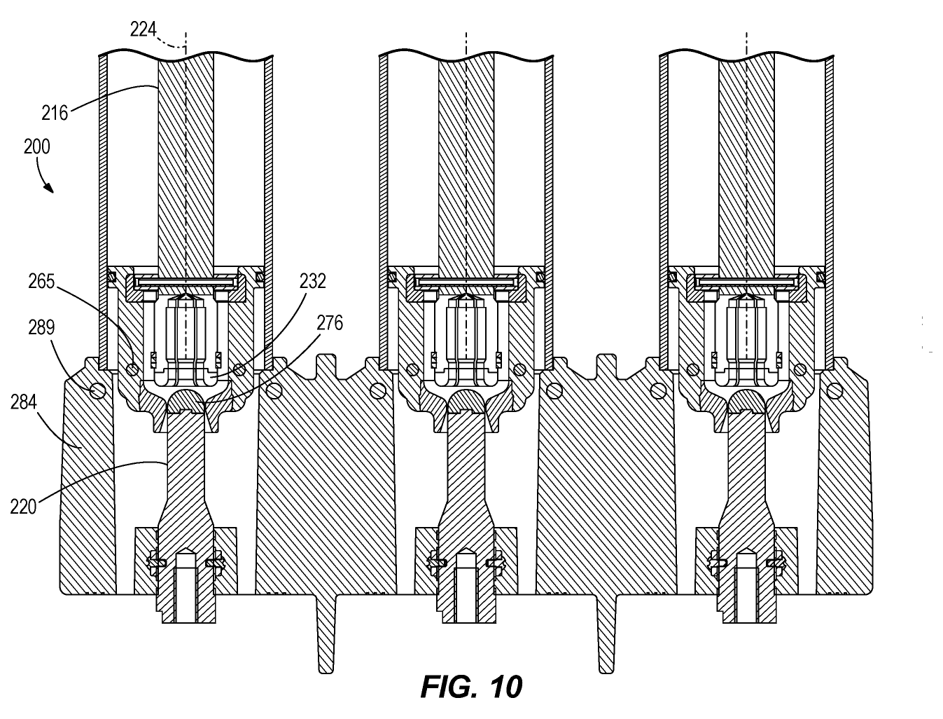

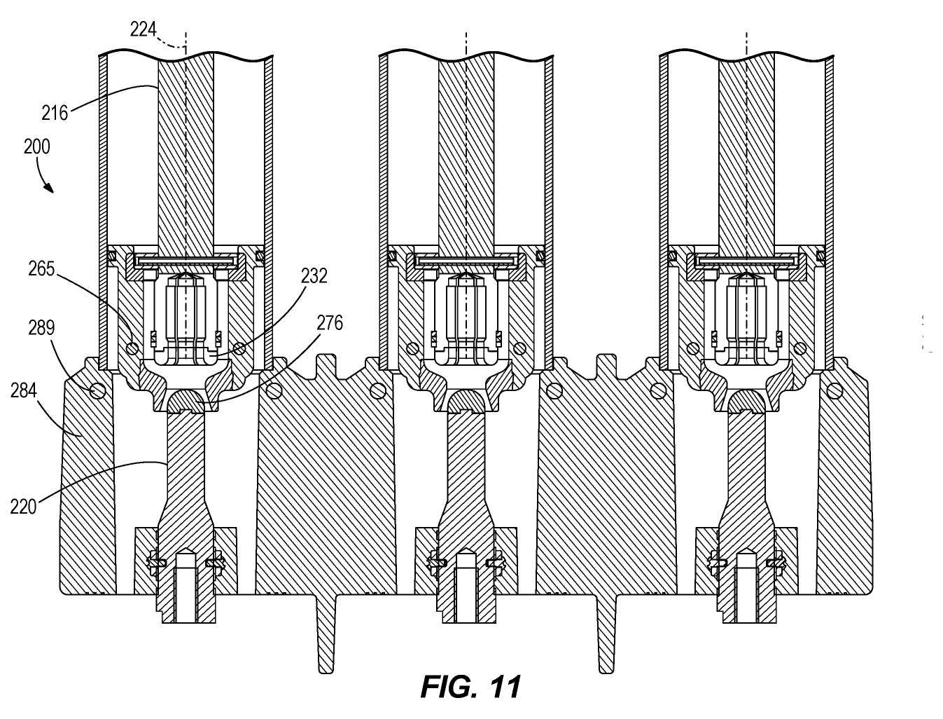

The first overmold 140 is cylindrical and composed of an electrically insulating material. The first overmold 140 is molded (i.e., injection molded, casting, overmold, etc.) with the nozzle 152 and the flange 156 in place, such that a portion of the flange 156 and the lip 160 of the nozzle 152 are embedded (i.e., integrated, etc.) within the first overmold 140. Furthermore, a first voltage screen 164 is embedded within the first overmold 140, such that no portion of the first voltage screen 164 is exposed. The first voltage screen 164 is composed of metal and is electrically connected to the movable conductor 116. The first voltage screen 164 is cylindrical in the illustrated embodiment and extends substantially the length of the first overmold 140. Specifically, the first voltage screen 164 extends from the flange 156 towards a distal end of the first overmold 140 along a direction parallel to the longitudinal axis 124. Thus, the first voltage screen 164 is coupled to the flange 156, which, in turn, is coupled to the mounting ring 148, thereby completing the electrical connection between the first voltage screen 164 and the movable conductor 116. In other embodiments (e.g., FIGS. 7-11), the first voltage screen 164 may have other shapes and constructions. The first voltage screen 164 emits an electrical field due to its electrical connection with the movable conductor 116. The first voltage screen 164 and its electrical field surround the tip 132, which in turn reduces the electrical stress concentration at the tip 132. The flange 156 and the mounting ring 148 are preferably composed of metal, but may alternatively be composed of other electrically conductive materials. The tip 132 is composed of copper-tungsten in some embodiments, but may be composed of other arc-suitable, electrically conductive materials.

As previously mentioned, the first overmold 140 seals against the inner periphery of the piston tube 108 via the seal 144, thereby dividing the piston tube 108 into a first chamber 168 disposed above the first overmold 140 (from a frame of reference of FIGS. 2-6) and a second chamber 172 disposed below the first overmold 140. In other words, the rod 128 is disposed within the first chamber 168 and the stationary conductor 120 is disposed within the second chamber 172. The first chamber 168 and the second chamber 172 of the piston tube 108 are filled with an inert, dielectric gas, and preferably a non-SF6 gas such as carbon dioxide, nitrogen, oxygen, air, or a blend of such gases. The dielectric gas may pass between the first chamber 168 and the second chamber 172 via apertures within the mounting ring 148 and the nozzle 152 during the opening process of the switch. The purpose of the gas pulse is to quench the electrical arc generated between the stationary and movable conductors 120, 116.

With continued reference to FIGS. 2-6, the stationary conductor 120 includes an electrode tip 176 disposed at a distal end of the stationary conductor 120. When the set of conductors 112 are moved to the closed state, the tip 176 is received within an aperture 180 of the electrode tip 132 of the movable conductor 116. The stationary conductor 120 extends from the base 104 along the longitudinal axis 124 toward the movable conductor 116. A second overmold 184 is disposed around the tip 176. In the illustrated embodiment, the second overmold 184 is integral with the base 104, while in other embodiments, the second overmold 184 and the base 104 may alternatively be separate components.

The second overmold 184 is cylindrical and composed of an electrically insulating material. The second overmold 184 and the base 104 are molded together (i.e., injection molded, casting, overmold, etc.), such that the second overmold 184 and the base 104 define a monolithic component. In other embodiments, the second overmold 184 and the base 104 may be separate components coupled together. Furthermore, a second voltage screen 188 is embedded within the second overmold 184, such that no portion of the second voltage screen 188 is exposed. As illustrated, the second overmold 184 receives the piston tube 108 and the second voltage screen 188 is disposed radially outward relative to the piston tube 108. The second voltage screen 188 is mechanically and electrically connected to the stationary conductor 120, and thus, the tip 176. The illustrated second voltage screen 188 is a cage and extends substantially the length of the second overmold 184. Specifically, the second voltage screen 188 extends from the base 104 towards a distal end of the second overmold 184 along a direction parallel to the longitudinal axis 124. In other embodiments, the second voltage screen 188 may have other shapes and constructions. The second voltage screen 188 surrounds the tip 176. The second voltage screen 188 is preferably composed of metal, but may alternatively be composed of other electrically conductive materials. The tip 176 is composed of copper-tungsten in the illustrated embodiment, but may be composed of other arc-suitable, electrically conductive materials.

Although the second voltage screen 188 may be in the form of a cage as shown within the second overmold 184 on the far left in FIG. 2, in other embodiments, an alternative voltage screen 192 may be employed in a different shape, such as a cylinder with a base that extends radially inward to mechanically and electrically connect to the stationary conductor 120 as shown within the second overmold 184 in the middle in FIG. 2.

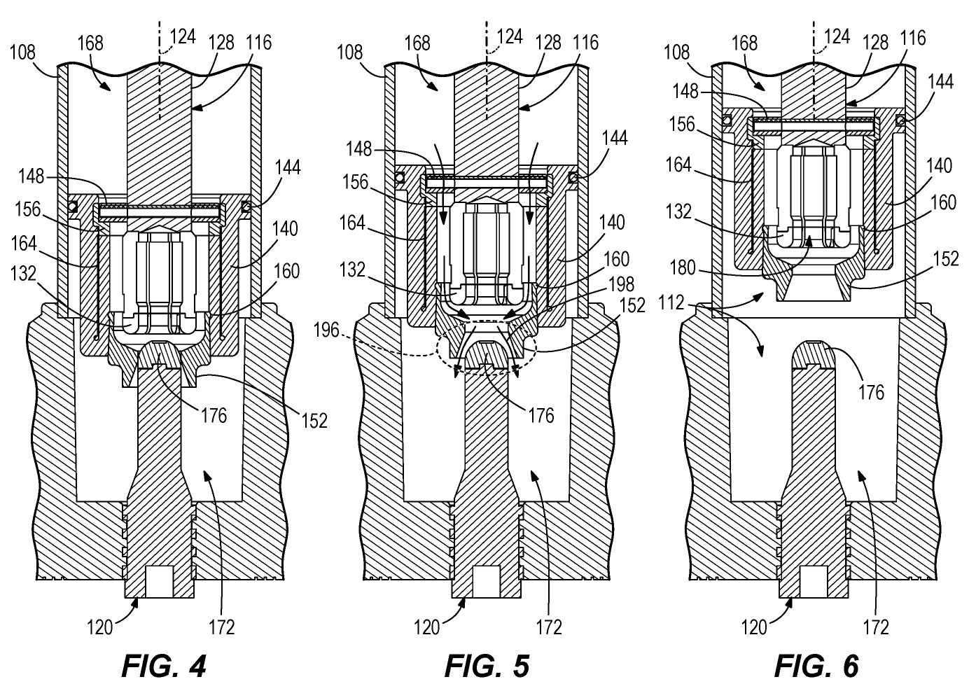

During operation, high-current electricity selectively flows through the electrical puffer switch assembly 100. For example, electrical current may flow in through the movable conductor 116 and out through the stationary conductor 120 when the set of conductors 112 are in the closed state. When the set of conductors 112 are in the open state, electrical current is inhibited from flowing through the electrical puffer switch assembly 100. As the set of conductors 112 are separating (i.e., moving from the closed state to the open state, as shown in FIGS. 4-6), electrical arcing may occur between the tip 132 of the movable conductor 116 and the tip 176 of the stationary conductor 120.

To limit or “quench” the arc, the dielectric gas is provided within the piston tube 108. To maximize arc quenching, the dielectric gas is compressed and moved toward the region where the arc forms (i.e., arcing region 196). In other words, directing a pulse 198 of the gas toward the arcing region 196—defined as the region between the electrode tips 132, 176 when the tip 132 of the movable conductor 116 is in close proximity to the tip 176 of the stationary conductor 120 (FIG. 5)—at high velocity improves arc quenching by interrupting the conductive path of the arc. The pulse 198 of the gas is generated via the nozzle 152 concurrently (or simultaneously) with the nozzle 152 disengaging the stationary conductor 120 (FIG. 5) and the gas moves from the first chamber 168 to the second chamber 172. Specifically, the dielectric gas in the first chamber 168 is acting on a first or larger cross-sectional area, at which point, the piston (i.e., the first overmold 140 and the rod 128) retracts toward the open state where the dielectric gas flows through and acts on the nozzle 152 having a second or smaller cross-section area toward the second chamber 172, thereby increasing the velocity of the gas (i.e., pulse of gas). The pulse 198 of gas is directed around the stationary conductor 120 and the arcing region 196 (FIG. 5) as the gas transfers from the first chamber 168 to the second chamber 172.

The pulse 198 of gas provides some arc quenching and may interrupt the flow of current, but the pulse 198 of gas may not completely quench the arc due to electrical stress that may be generated after the current is interrupted, also called Transient Recovery Voltage (TRV). Thus, the electrical stress may be concentrated between the tips of the movable conductor 116 and the stationary conductor 120, which may cause a dielectric breakdown during the interruption process (failure to interrupt current due to the TRV), increased wear/erosion, and decreased life of the electrode tips 132, 176. In the illustrated embodiment, however, the first voltage screen 164 and the second voltage screen 188 produce electric fields since they are electrically connected to the set of conductors 112, which serves to reduce the electrical stress at the tip of the electrodes during the opening sequence, resulting in a successful arc interruption, less wear, and increased life of the electrode tips 132, 176.

To assemble the electrical puffer switch assembly 100, the first overmold 140 and the second overmold 184 must be formed via an overmolding process. Specifically, the first voltage screen 164, the flange 156, and the nozzle 152 are held stationary in a mold (or cast) having a cavity in the shape of the first overmold 140. The electrically insulating epoxy material is then injected into the cavity of the mold, such that the first voltage screen 164, the flange 156, and the nozzle 152 are integrally formed with the first overmold 140. Once the first overmold 140 is molded, the first voltage screen 164 is completely embedded in the first overmold 140 such that no portion of the first voltage screen 164 is exposed, whereas only portions of the nozzle 152 and the flange 156 are embedded in the first overmold 140 such that portions of the nozzle 152 and the flange 156 are exposed. Next, the first overmold 140 is coupled to the movable conductor 116 in a manner where the first overmold 140 surrounds the electrode tip 132. The mounting ring 148 is coupled to the rod 128, and the flange 156 is then coupled to the mounting ring 148 via the series of fasteners 154, thereby coupling the first overmold 140 to the rod 128 of the movable conductor 116.

The second overmold 184 (and/or the base 104) is formed via a similar process. That is, the stationary conductor 120 and the second voltage screen 188 (or the alternative screen 192) are held stationary in a mold (or cast) having a cavity in the shape of the second overmold 184 and the base 104. The electrically insulating material is then injected into the cavity of the mold, such that the stationary conductor 120 and the second voltage screen 188 (or screen 192) are integrally formed with the second overmold 184. Once the second overmold 184 is molded, the second voltage screen 188 (or screen 192) is completely embedded in the second overmold 184 such that the second voltage screen 188 (or screen 192) surrounds the stationary conductor 120 and no portion of the second voltage screen 188 (or screen 192) is exposed. Next, the piston tubes 108 are coupled to the base 104. Specifically, the piston tubes 108 are received by the inner periphery of the second overmold 184. At this point, the dielectric gas may be introduced into the piston tubes 108, and more specifically, into the first chamber 168 and the second chamber 172.

FIGS. 7-12 illustrate an electrical puffer switch assembly 200 according to another embodiment of the present disclosure. The electrical puffer switch assembly 200 is similar to the electrical puffer switch assembly 100 described above with reference to FIGS. 1-6, and features of the electrical puffer switch assembly 200 corresponding with features of the electrical puffer switch assembly 100 are given corresponding reference numbers plus ‘100’. The following description focuses primarily on differences between the electrical puffer switch assembly 200 and the electrical puffer switch assembly 100, and it should be understood that features and aspects of the electrical puffer switch assembly 100 may be incorporated into the electrical puffer switch assembly 200, and vice versa.

With reference to FIG. 7, the first voltage screen 264 is embedded within the first overmold 240 and electrically connected to the movable conductor 216. The first voltage screen 264 includes a first ring 265, a plurality of legs 267 extending from the first ring 265, and a first collar 269 coupled to the plurality of legs 267 opposite the first ring 265. The illustrated first ring 265 has a circular cross-section, such that the first ring 265 is toroidal. The first collar 269 is electrically connected to the movable conductor 216, such that the first ring 265 is electrically connected to the movable conductor 216 through the legs 267 and the first collar 269.

With continued reference to FIG. 7, the second voltage screen 288 is embedded within the second overmold 284/base 204 and includes a second ring 289, a plurality of legs 291 extending from the second ring 289, and a second collar 293 coupled to the plurality of legs 291 opposite the second ring 289. The illustrated second ring 289 has a circular cross-section, such that the second ring 289 is also toroidal. The second collar 293 is sleeved around and electrically connected to the stationary conductor 220, such that the second ring 289 is electrically connected to the stationary conductor 220 through the legs 291 and the second collar 293.

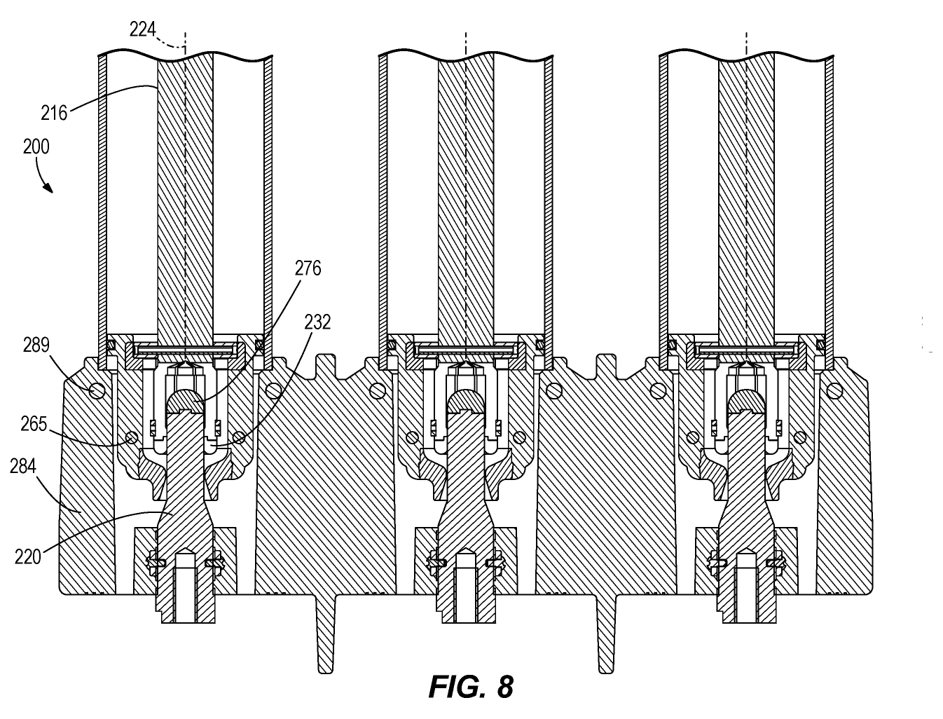

With reference to FIG. 8, the first ring 265 is around the movable conductor 216 and at least partially offset along the longitudinal axis 224 from the tip 232 of the movable conductor 216. The second ring 289 extends at least partially beyond the tip 276 of the stationary conductor 220.

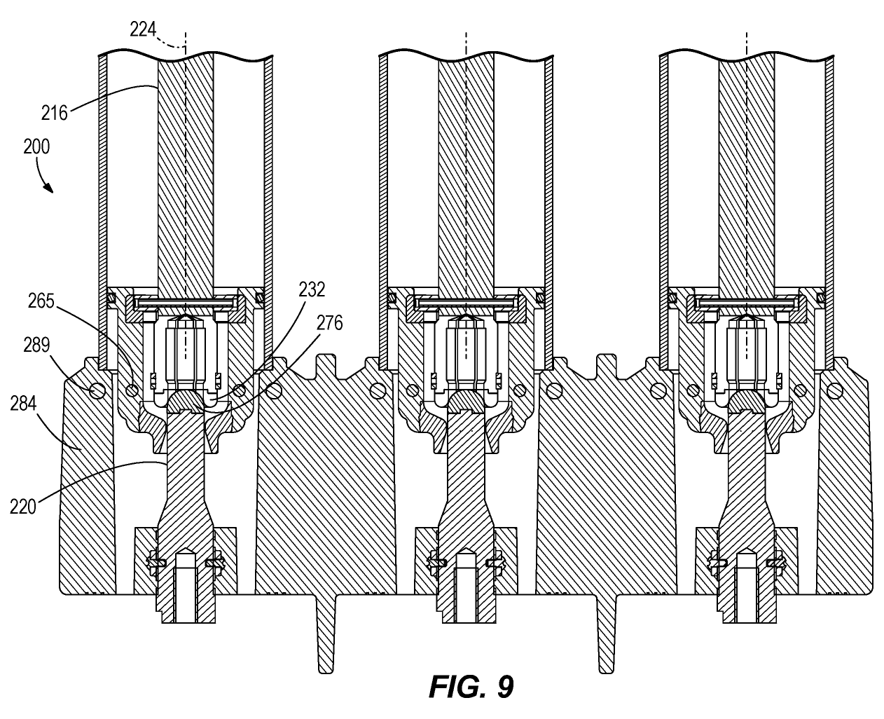

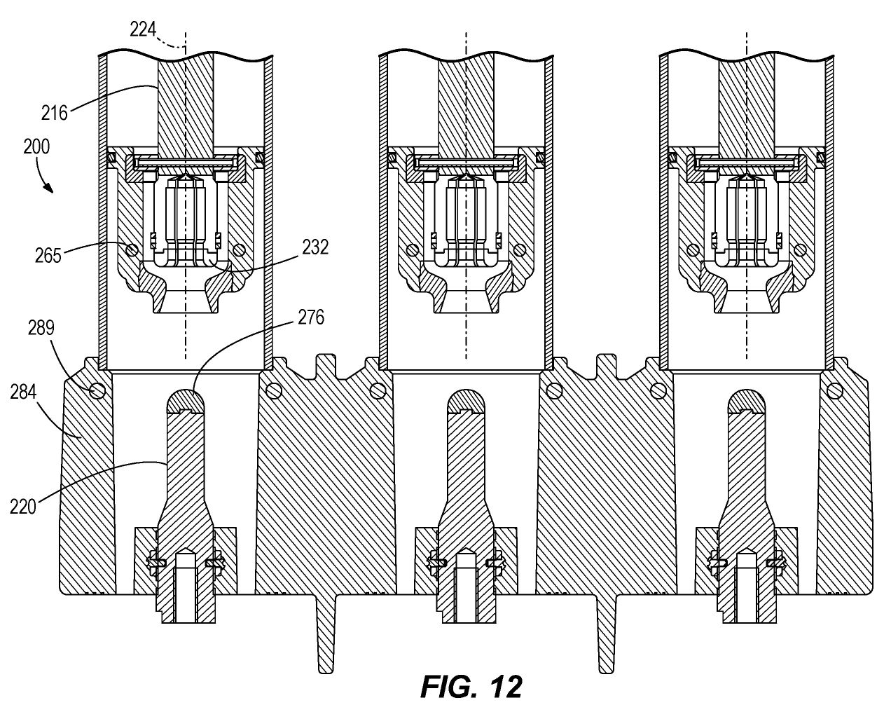

FIGS. 8-12 illustrate a sequence of the movable conductor 216 moving away from the stationary conductor 220 from the closed position (FIG. 8) to the open position (FIG. 12). FIG. 9 illustrates the tips 232, 276 in point contact just before separating (i.e., the point where arcing may first begin to occur). In this position, the first and second rings 265, 289 are at an axially aligned position – that is, a plane perpendicular to the longitudinal axis 224 may pass through both the rings 265, 289. This arrangement may provide reduced arcing and improved electrical stress reduction.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. An electrical switch assembly comprising:
a stationary conductor having a stationary electrode; and
a movable conductor movable relative to the stationary conductor between a closed position, in which the movable conductor and the stationary conductor are electrically connected, and an open position, in which the movable conductor and the stationary conductor are separated to interrupt the electrical connection between the movable conductor and the stationary conductor;
a piston tube configured to slidably receive the movable conductor;
a nozzle coupled to the movable conductor, the nozzle configured to compress a dielectric gas and direct a pulse of the gas around the stationary conductor in response to movement of the movable conductor from the closed position toward the open position;
an electrically insulating overmold surrounding a tip portion of the movable conductor; and
a voltage screen electrically connected to the movable conductor.

2. The electrical switch assembly of claim 1, wherein the voltage screen is embedded within the overmold.

3. The electrical switch assembly of claim 1, wherein the voltage screen is a first voltage screen, and wherein the electrical switch assembly further comprises a second voltage screen electrically connected to the stationary conductor.

4. The electrical switch assembly of claim 3, wherein the overmold is a first overmold, wherein the electrical switch assembly further comprises a second overmold receiving an end of the piston tube.

5. The electrical switch assembly of claim 4, wherein the second voltage screen is embedded within the second overmold.

6. The electrical switch assembly of claim 5, wherein the first and second overmolds are both made of an electrically insulating epoxy material.

7. The electrical switch assembly of claim 1, wherein the stationary conductor is one of a plurality of stationary conductors, and wherein the movable conductor is one of a plurality of movable conductors, each movable in unison relative to the plurality of stationary conductors between the closed position and the open position.

8. The electrical switch assembly of claim 1, wherein the piston tube defines a longitudinal axis, and wherein the movable conductor moves along the longitudinal axis.

9. The electrical switch assembly of claim 1, wherein the dielectric gas is a non-SF6 gas.

10. The electrical switch assembly of claim 9, wherein the dielectric gas includes carbon dioxide.

11. The electrical switch assembly of claim 1, wherein the voltage screen includes a ring surrounding the movable conductor.

12. The electrical switch assembly of claim 11, wherein the voltage screen is a first voltage screen, and wherein the electrical switch assembly further comprises a second voltage screen electrically connected to the stationary conductor.

13. The electrical switch assembly of claim 12, wherein the second voltage screen includes a ring surrounding the movable conductor when the movable conductor is in the closed position.

14. The electrical switch assembly of claim 13, wherein the movable conductor is movable along a longitudinal axis, and wherein at least a portion of the ring of the second voltage screen extends beyond a tip of the stationary conductor.

15. A method of manufacturing an electrical switch assembly, the method comprising:
providing a piston tube;
embedding a first voltage screen into a first electrically-insulating epoxy overmold;
coupling the first electrically-insulating epoxy overmold to a movable conductor;
inserting the movable conductor within the piston tube;
embedding a second voltage screen into a second electrically-insulating epoxy overmold;
coupling the second electrically-insulating epoxy overmold to a stationary conductor; and
coupling the piston tube to the second electrically-insulating epoxy overmold.

16. The method of claim 15, further comprising electrically connecting the first voltage screen and the movable conductor, and electrically connecting the second voltage screen and the stationary conductor.

17. An electrical switch assembly comprising:
a stationary conductor having a stationary electrode; and
a movable conductor movable relative to the stationary conductor between a closed position, in which the movable conductor and the stationary conductor are electrically connected, and an open position, in which the movable conductor and the stationary conductor are separated to interrupt the electrical connection between the movable conductor and the stationary conductor;
a piston tube configured to slidably receive the movable conductor;
a nozzle coupled to the movable conductor, the nozzle configured to compress a dielectric gas and direct a pulse of the gas around the stationary conductor in response to movement of the movable conductor from the closed position toward the open position;
a first electrically insulating overmold surrounding a tip portion of the movable conductor;
a second electrically insulating overmold surrounding the stationary electrode;
a first voltage screen embedded within the first electrically insulating overmold and electrically connected to the movable conductor; and
a second voltage screen embedded within the second electrically insulating overmold and electrically connected to the stationary conductor.

18. The electrical switch assembly of claim 17, wherein the first voltage screen includes a first ring surrounding the movable conductor, and the second voltage screen includes a second ring surrounding the stationary conductor.

19. The electrical switch assembly of claim 18, wherein the movable conductor is movable along a longitudinal axis, and wherein the first ring is partially offset along the longitudinal axis from the tip of the movable conductor.

20. The electrical switch assembly of claim 18, wherein the first ring surrounds both the movable conductor and the stationary conductor in the closed position.
